(19) United States
(12) Patent Application Publication
(10) Pub. No.: US 2009/0035474 A1
(43) Pub. Date: Feb. 5, 2009

(54) Refractories with improved hydration resistance

(75) Inventor: H. David Prior, Bethel Park, PA (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: North American Refractories Co.

(21) Appl. No.: 11/888,740

(22) Filed: Aug. 2, 2007

(51) Int. Cl. B05D 3/02

(52) U.S. Cl. 427/393.6

(57) ABSTRACT

A method of improving the hydration resistance of refractories containing free MgO and/or CaO, comprising the steps of:
forming a refractory product containing free MgO and/or CaO;
applying a drying oil to the refractory product; and
curing the drying oil.

### FIELD OF THE INVENTION

The present invention relates to refractory products, and more specifically, to refractory products containing free MgO and/or free CaO having improved hydration resistance.

### BACKGROUND OF THE INVENTION

Free MgO and/or free CaO are found in many types of refractories. As used herein, the terms “free MgO” and “free CaO” refer to oxides that are not combined with other oxides to form different mineralogical phases. Examples of refractories containing free MgO and/or free CaO include burned magnesia brick, burned magnesia-chrome brick, burned dolomite brick, resin bonded alumina-magnesia-carbon brick and magnesia-carbon brick.

A problem with such materials is that they are subject to hydration from reaction with water from atmospheric humidity and/or other sources. Cracking and crumbling can result from hydration of a refractory material containing free MgO and/or free CaO.

Hydration resistance of bricks containing free MgO and/or free CaO has been improved by dipping such bricks into solutions of boric acid or magnesium sulfate. The addition of both materials has been shown to improve hydration resistance. While effective in improving hydration resistance, these solutions have disadvantages. In the case of boric acid, it is known that a boric acid when heated is converted to boron oxide, which is a powerful flux in magnesia-based refractories. In addition, dipping refractory products into aqueous solutions generally requires that the refractory product be dried afterwards to remove excess water. Such a process consumes both time and energy.

Another way of improving hydration resistance of bricks containing free MgO and/or free CaO has been to add boric acid to the brick batch at the time of mixing and forming the brick. This process avoids dipping a brick into a boric acid solution; however, the problem with the boric acid acting as a flux in the refractory still remains.

It has also been known to try to improve the hydration resistance of bricks containing burned dolomite grain by impregnating such bricks with wax or pitch to improve hydration resistance.

The present invention provides a method of improving the hydration resistance of refractory products containing free MgO and/or free CaO, which process does not use materials that introduce a flux agent into the refractory product.

### SUMMARY OF THE INVENTION

In accordance with a preferred embodiment of the present invention, there is provided a method of improving the hydration resistance of refractories containing free MgO and/or CaO, comprising the steps of:
forming a refractory product containing free MgO and/or CaO;
applying a drying oil to the refractory products; and
curing the drying oil.

An advantage of the present invention is a method of improving the hydration resistance of a refractory product.

Another advantage of the present invention is a method of improving the hydration resistance of a refractory product containing free MgO and/or free CaO.

Another advantage of the present invention is a method of improving the hydration resistance of a refractory product as described above that does not utilize pitch or wax.

A still further advantage of the present invention is a method of improving the hydration resistance of a refractory product as described above that does not include boric acid or magnesium sulfate.

A still further advantage of the present invention is a method of improving the hydration resistance of a refractory product as described above, which method does not include a water-based material that requires a drying step to remove excess water.

A still further advantage of the present invention is a method of improving the hydration resistance of a refractory product as described above that can be performed at room temperature.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying photographs which form a part hereof, and wherein:

FIG. 1 is a photograph showing a refractory brick containing free MgO;

FIG. 2 is a photograph of the refractory brick shown in FIG. 1 after one (1) hour of exposure in an autoclave to 324° F. under 80 psi of steam pressure;

FIG. 3 is a photograph of a refractory brick as shown in FIG. 1 that was soaked in a drying oil at room temperature;

FIG. 4 is a photograph of the refractory brick shown in FIG. 3 after one (1) hour of exposure in an autoclave to 324° F. under 80 psi of steam pressure;

FIG. 5 is a is a photograph of the refractory brick shown in FIG. 3 after two (2) hours of exposure in an autoclave to 324° F. under 80 psi of steam pressure; and

FIG. 6 is a is a photograph of the refractory brick shown in FIG. 3 after five (5) hours of exposure in an autoclave to 324° F. under 80 psi of steam pressure.

### DETAILED DESCRIPTION OF PREFERRED EMBODIMENT

Referring now to the drawings wherein the showings are for the purpose of illustrating a preferred embodiment of the invention only, and not for the purpose of limiting same, the present invention relates to a method of improving the hydration resistance of a refractory product. The invention is particularly applicable to improving the hydration resistance of refractory bricks containing free MgO and/or free CaO, and shall be described with particular reference thereto, it being understood that the present invention finds advantageous application in improving the hydration resistance of other refractory materials.

In accordance with the present invention, refractory products containing free MgO and/or free CaO are formed. The hydration resistance of the refractory product is improved by applying a drying oil or drying oils to the refractory product. As used herein, the term “drying oil” is used to describe an oil that hardens to a tough, solid film after a period of exposure to air. The hardening, or more properly curing of the oil is a result of an exothermic reaction in the form of autoxidation. In this process, oxygen attacks the hydrocarbon chain, touching off a series of addition reactions. As a result, the oil polymerizes, forming long, chain-like molecules. Following the autoxidation stage, the oil polymers cross-link forming bonds between neighboring molecules, resulting in a vast polymer network. Drying oils that are suitable for use include, by way of example and not limitation, linseed oil, tung oil, boiled linseed oil, polymerized tung oil, walnut oil, sunflower oil, safflower oil and poppy oil. It is also contemplated that refined products derived from drying oils may also be used. Such refined products include linolenic acid and linoleic acid. It is also contemplated that drying oils or refined products from drying oils that are reacted to other substances but which retain the property of drying oils (i.e., reaction with atmospheric oxygen to cure to a solid state with or without the application of heat) can also be used. Examples of these latter materials are the family of alkyd resins. As will be appreciated by those skilled in the art, drying oils containing solvents will also be applicable for use in the present invention. Other materials that would be suitable include various unsaturated fatty acids and derivatives thereof with or without drying agents. These latter materials include arachnidonic acid, vacceric acid, oleic acid, EPA (pentaenoic acid), DHA (hexaenoic acid), eicosatetraenoic acid and palmitoleic acid.

The foregoing materials may be applied to the refractory product by spraying, painting, dipping or impregnation by a vacuum-pressure process.

It is contemplated that the foregoing process of treating refractory products with drying oil(s) can be done to achieve a surface coating or to achieve partial impregnation or full impregnation of the porosity of the refractory product by the drying oils.

As indicated above, the drying oils harden, i.e., cure, by means of autoxidation. In this respect, treating refractory products with drying oils has the advantage that it can be performed without a subsequent drying step. However, it will be appreciated that in some instances, the application of heat to treat a refractory product may be desirable, for example, when there is a desire to speed up the process of hardening of the drying oils.

The present invention shall now be further described by way of example. A series of tests are conducted by placing brick samples into an autoclave at 324° F. under 80 psi of steam pressure. Bricks comprised of a magnesia-spinel composition are used. The magnesia-spinel brick contains approximately 84% MgO, 12.5% Al₂O₃ and small amounts of other oxides.

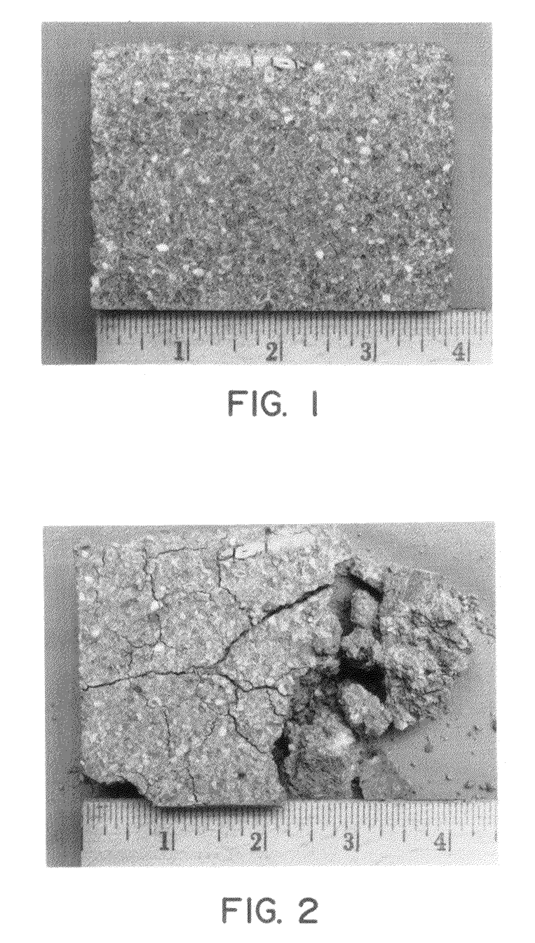

An untreated magnesia-spinel brick of the foregoing composition is shown in FIG. 1. The brick was placed in an autoclave at 324° F. under 80 psi of steam pressure. FIG. 2 shows the same brick after one hour in the autoclave. The cracking and crumbling of the brick after one hour was the result of hydration of the brick.

A brick of the same composition, i.e., containing approximately 84% MgO, 12.5% Al₂O₃ and small amounts of other oxides was soaked in boiled linseed oil at room temperature. The brick samples were placed in the boiled linseed oil. Bubbles coming out of the brick indicate penetration of the linseed oil. The brick was soaked until no additional bubbles came out of the brick, suggesting that the brick was fully impregnated with the boiled linseed oil to the degree possible under one atmosphere of pressure. The brick was removed from the linseed oil and was allowed to dry in air over-night. The brick was placed in an autoclave at 324° F. under 80 psi of steam pressure.

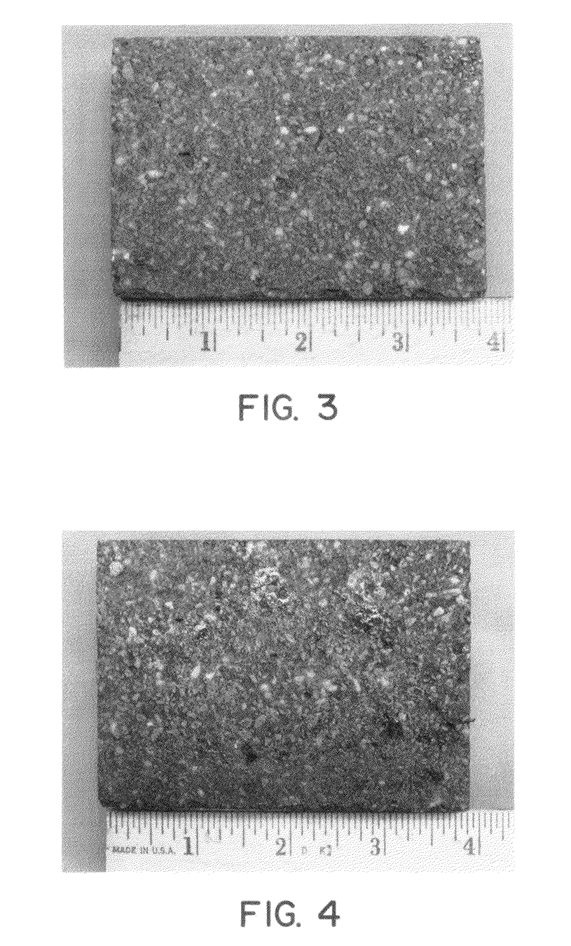

FIG. 3 shows the brick soaked in boiled linseed oil before placement in the autoclave. FIG. 4 shows the brick soaked in boiled linseed oil after one hour in the autoclave.

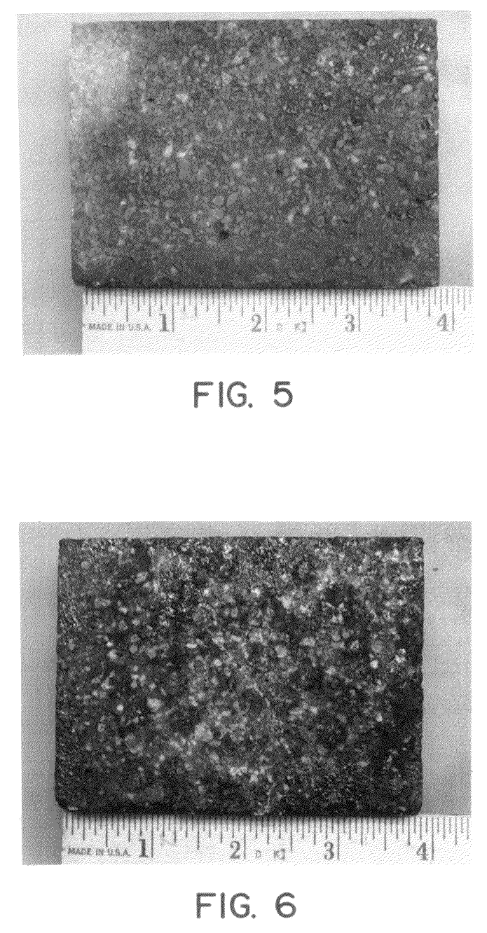

FIG. 5 shows the brick soaked in boiled linseed oil after two hours in the autoclave.

FIG. 6 shows the brick soaked in boiled linseed oil after five hours in the autoclave.

As shown in FIGS. 4, 5 and 6, the hydration resistance of a magnesia-spinel brick is substantially improved by soaking the brick in boiled linseed oil; whereas, the untreated magnesia-spinel brick cracked and crumbled after one hour in the autoclave test. A brick of the identical composition treated with boiled linseed oil was unaffected after five hours of the same exposure.

The present invention thus provides a method of improving the hydration resistance of refractory products, and more specifically, of refractory products, such as refractory bricks containing free MgO and/or free CaO. The use of drying oils does not require the step of heating the refractory as was required when impregnating refractory bricks with water-based solutions. Moreover, drying oils are liquid at room temperature and do not require energy to fluidize them as required with pitch or wax coatings.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A method of improving the hydration resistance of refractories containing free MgO and/or CaO, comprising the steps of:
forming a refractory product containing free MgO and/or CaO;
applying a drying oil to said refractory product; and
curing said drying oil.

2. A method of improving the hydration resistance of refractories as defined in claim 1, wherein said step of applying said drying oil is comprised of spraying said refractory product with a drying oil.

3. A method of improving the hydration resistance of refractories as defined in claim 1, wherein said step of applying said drying oil is comprised of painting said refractory product with a drying oil.

4. A method of improving the hydration resistance of refractories as defined in claim 1, wherein said step of applying said drying oil is comprised of dipping said refractory product in said drying oil.

5. A method of improving the hydration resistance of refractories as defined in claim 1, wherein said step of applying said drying oil is comprised of impregnation by a vacuum-pressure process.

6. A method of improving the hydration resistance of refractories as defined in claim 1, wherein said refractory product is a brick.

7. A method of improving the hydration resistance of refractories as defined in claim 1, wherein said drying oil is at least one of the following: linseed oil, boiled linseed oil, tung oil, walnut oil, sunflower oil, safflower oil, poppy oil, linolenic acid or linoleic acid.

8. A method of improving the hydration resistance of refractories as defined in claim 1, wherein the outer surface of said refractory product is impregnated with said drying oil.

9. A method of improving the hydration resistance of refractories as defined in claim 1, wherein said refractory product is fully impregnated with said drying oil.
